(19) United States
(12) Patent Application Publication
(10) Pub. No.: US 2020/0325942 A1
(43) Pub. Date: Oct. 15, 2020

(54) DEVICE FOR VIBRATION DECOUPLING OF TWO SHAFT SECTIONS

(71) Applicant: Süddeutsche Gelenkscheibenfabrik GmbH & Co. KG, Waldkraiburg (DE)

(72) Inventors: Steffen Jerye, Haag (DE); Wolfgang Orthofer, JR., Muehldorf a. Inn (DE); Domen Stadler, Waldkraiburg (DE); Joachim Reihle, Schnaitsee (DE)

(73) Assignee: Süddeutsche Gelenkscheibenfabrik GmbH & Co. KG, Waldkraiburg (DE)

(21) Appl. No.: 16/845,484

(22) Filed: Apr. 10, 2020

(30) Foreign Application Priority Data
Apr. 10, 2019 (DE) 102019002648.9

(51) Int. Cl. F16D 3/12; F16D 3/06

(52) U.S. Cl. CPC F16D 3/12; F16D 2300/22; F16D 3/06

(57) ABSTRACT

A device is provided for vibration decoupling of two shaft sections having at least one core that has a radial outer contour with radial protruding sections and that is connectable to one of the shaft sections, an outer sleeve that has at least one receiving section, the receiving section having a radial inner contour with radial receiving areas, the outer sleeve having a connecting section for connection to one of the shaft sections, wherein the radial outer contour of and the radial inner contour have a mutually complementary design, wherein the core is accommodated in the receiving section, and wherein at least one first damping layer is situated in the radial direction between the radial inner contour and the radial outer contour, and wherein at least one second damping layer extends in the axial direction between a first end-face surface of the core and the receiving section.

The present invention relates to a device for vibration decoupling of two shaft sections. In particular the present invention relates to a device for vibration decoupling of two shaft sections of a drive shaft or a side shaft of a vehicle.

### BACKGROUND OF THE INVENTION

Devices of the type disclosed in German unexamined patent application DE 10 2012 009 942 A1 are known from the prior art. German unexamined patent application DE 10 2012 009 942 A1 l discloses a drive train having a differential, two drive wheels, and a universal joint shaft, having an inner joint and/or outer joint, situated between the differential and one of the drive wheels. The inner joint and/or outer joint have/has a joint housing for transmitting torsional moments over a solid bending angle between a drive side and an output side of the universal joint shaft. The joint housing has a first housing part and a second housing part that are coupled together, a damping element being situated at a coupling point between the first housing part and the second housing part.

The object of the present invention is to provide a device for vibration decoupling of two shaft sections, via which vibrations may be reduced.

### BRIEF SUMMARY OF THE INVENTION

This object is achieved with a device is provided for vibration decoupling two shaft sections, in particular, two shaft sections of a drive shaft of a vehicle. In one embodiment, the device comprises at least one core that has a radial outer contour with radial protruding sections and that is connectable to one of the shaft sections; an outer sleeve that has at least one receiving section, the at least one receiving section having a radial inner contour with radial receiving areas, the outer sleeve having a connecting section for connection to one of the shaft sections. The radial outer contour of the at least one core and the radial inner contour of the at least one receiving section have a mutually complementary design, wherein the at least one core is accommodated in the at least one receiving section of the outer sleeve, and wherein at least one first damping layer is situated in the radial direction between the radial inner contour of the at least one receiving section and the radial outer contour of the core, and wherein at least one second damping layer extends in the axial direction between a first end-face surface of the at least one core and the at least one receiving section.

In a further embodiment, at least the radial inner contour of the at least one receiving section has a conical design, at least in one section. In another embodiment, the radial inner contour of the at least one receiving section has a section in which the radial inner contour extends at least essentially parallel to the longitudinal axis (L). In another embodiment, the radial inner contour of the at least one receiving section has at least one step. In another embodiment, the at least one first damping layer has at least one section in which the radial thickness (d) of the at least one first damping layer changes. In another embodiment, the at least one first damping layer has at least one section in which its radial thickness (d) remains constant. In another embodiment, the at least one first damping layer has at least one step at which the radial thickness of the at least one first damping layer abruptly changes. In another embodiment, the device has a third damping layer that extends along a second end-face surface of the at least one core. In another embodiment, the device has at least one closure element that holds the at least one core in the receiving section of the outer sleeve. In another embodiment, at least the at least one first damping layer and the at least one second damping layer are fixedly mounted on the at least one core. In another embodiment, the at least one core and/or the connecting section of the outer sleeve have/has at least one opening for accommodating a shaft section. In another embodiment, the at least one opening in the at least one core and/or the at least one opening in the outer sleeve have/has at least one section having toothing. In another embodiment, the at least one core and/or the connecting section of the outer sleeve are/is designed with a shaft section. In another embodiment, the device is for use with a drive shaft of a vehicle, in particular a front wheel drive vehicle or rear wheel drive vehicle and/or a vehicle having an electric drive.

In another embodiment, a drive shaft is provided for a vehicle, in particular a front wheel drive vehicle and/or a vehicle having an electric drive, having a device comprising at least one core that has a radial outer contour with radial protruding sections and that is connectable to one of the shaft sections; an outer sleeve that has at least one receiving section, the at least one receiving section having a radial inner contour with radial receiving areas, the outer sleeve having a connecting section for connection to one of the shaft sections. The radial outer contour of the at least one core and the radial inner contour of the at least one receiving section have a mutually complementary design, wherein the at least one core is accommodated in the at least one receiving section of the outer sleeve, and wherein at least one first damping layer is situated in the radial direction between the radial inner contour of the at least one receiving section and the radial outer contour of the core, and wherein at least one second damping layer extends in the axial direction between a first end-face surface of the at least one core and the at least one receiving section. In one embodiment, the drive shaft has at least one articulated joint and the device has a distance from the at least one articulated joint or is integrated into the at least one articulated joint.

In another embodiment, an articulated joint is provided having a device comprising at least one core that has a radial outer contour with radial protruding sections and that is connectable to one of the shaft sections; an outer sleeve that has at least one receiving section, the at least one receiving section having a radial inner contour with radial receiving areas, the outer sleeve having a connecting section for connection to one of the shaft sections. The radial outer contour of the at least one core and the radial inner contour of the at least one receiving section have a mutually complementary design, wherein the at least one core is accommodated in the at least one receiving section of the outer sleeve, and wherein at least one first damping layer is situated in the radial direction between the radial inner contour of the at least one receiving section and the radial outer contour of the core, and wherein at least one second damping layer extends in the axial direction between a first end-face surface of the at least one core and the at least one receiving section. The device is integrated into the articulated joint.

The device according to the invention for vibration decoupling of two shaft sections includes at least one core that has a radial outer contour with radial protruding sections and that is connectable to one of the shaft sections, and an outer sleeve that has at least one receiving section with a radial inner contour, the radial inner contour having radial receiving areas. The outer sleeve also has a connecting section for connection to one of the shaft sections. The radial outer contour of the at least one core and the radial inner contour of the at least one receiving section have a mutually complementary design. The at least one core is accommodated in the at least one receiving section. At least one first damping layer is situated in the radial direction between the inner contour of the receiving section and the outer contour of the core. The at least one second damping layer extends in the axial direction between a first end-face surface of the core and the receiving section of the outer sleeve. Torques may be transmitted between the two shaft sections by use of the device according to the invention. The device according to the invention vibrationally decouples the two shaft sections from one another. The device according to the invention may provide the vibration decoupling for bending vibrations as well as for rotational vibrations. This is achieved in particular by the first damping layer, which extends in the radial direction between the outer contour of the core and the inner contour of the receiving section of the outer sleeve. In other words, the first damping layer may provide vibration decoupling in the axial direction and/or in the radial direction. The second damping layer, which is provided between the first end-face surface of the core and the receiving section of the outer sleeve, is used for pretensioning in the axial direction. In addition, the second damping layer may contribute to the radial pretensioning of the first damping layer. The device according to the invention may thus provide torsional decoupling and translatory decoupling of the two shaft sections.

The inner contour of the at least one receiving section of the outer sleeve may have a conical design at least in one section. The receiving section of the outer sleeve may have a conical design in at least one section; i.e., the inner contour as well as the outer contour may have a conical design. The inner contour of the receiving section may conically expand in the direction of an open end of the receiving section. The receiving section may have a base. The base may form the end of the receiving section opposite from the open end of the receiving section. The second damping layer may extend in the axial direction between the first end-face surface of the core and the base of the receiving section.

The inner contour of the at least one receiving section may have a section in which the inner contour extends at least essentially parallel to the longitudinal axis of the outer sleeve. This parallel section of the inner contour may extend, starting from the base of the receiving section, and merge into the conically shaped section. The inner contour of the at least one receiving section may have at least one step. The step may have a surface that extends in the radial direction or at an angle to the longitudinal axis of the outer sleeve. The step may form the transition between the section of the inner contour extending parallel to the longitudinal axis and the conically shaped section of the inner contour.

The at least one first damping layer may have at least one section in which the radial thickness of the at least one first damping layer changes over the axial extension of the at least one damping layer. The radial thickness of the at least one first damping layer may change along at least one section of the axial extension of the at least one core. The change in the radial thickness of the first damping layer may take place continuously along its axial extension.

The at least one first damping layer may have at least one section in which its radial thickness remains constant. The at least one section with a constant radial thickness and the at least one section with a changing radial thickness may adjoin one another in the axial direction. The at least one first damping layer may have at least one step at which the radial thickness of the at least one damping layer changes abruptly. The at least one step of the first damping layer may form the transition between the section having a constant radial thickness and the section having a changing radial thickness. The first damping layer may have a relatively small radial thickness in the section having a constant radial thickness. The radial thickness of the damping layer may abruptly increase at the at least one step before it essentially continuously increases in the section with an increasing radial thickness. Multistep rigidity of the device may be achieved via the different radial thicknesses of the first damping layer. This may apply in particular for the rigidity in the torsional direction. As a result of the different radial thicknesses, a rigidity characteristic curve of the device may be achieved that has a soft zero crossing and progressively increasing rigidity.

The device may have at least one third damping layer that extends on a second end-face surface of the at least one core. The third damping layer may be connected to the second damping layer. The first damping layer and/or the second damping layer may have an essentially constant axial thickness. In addition, the second damping layer may likewise be connected to the second damping layer. The first, second, and third damping layers may together essentially completely enclose the at least one core.

The device may have at least one closure element that holds the at least one core in the receiving section of the outer sleeve. At least the first damping layer and the second damping layer may be axially pretensioned via the at least one closure element. Setting behavior of the elastic material of the damping layers may thus be reduced or compensated for. This may result in an increased service life of the device. In addition, the radial rigidity of the device may be adjusted via the axial pretensioning of the damping layers. For this reason, the device may have relatively high radial rigidity. The third damping layer may extend in the axial direction between the second end-face surface and the at least one closure element.

The at least one core may be completely accommodated in the at least one receiving section. The entire axial extension of the at least one core may be situated within the at least one receiving section of the outer sleeve. In other words, the two axial end-face surfaces of the core are situated within the axial extension of the receiving section. The at least one core with the first end-face surface may be supported on the base of the receiving section via the second damping layer.

At least the at least one first damping layer and the at least one second damping layer may be fixedly mounted on the at least one core. The first damping layer may be fixedly mounted on the radial outer contour of the core. The second damping layer may be fixedly mounted on the first end-face surface of the core. The third damping layer may be fixedly mounted on the second end-face surface. The damping layers may be vulcanized to the at least one core. The at least one core together with the damping layers may form a unit. This unit may be inserted into the receiving section of the outer sleeve. The unit formed by the core and the damping layers may be held in the receiving section via the at least one closure element, wherein the at least one closure element may contribute to the axial pretensioning of the damping layers.

The at least one core may have at least one opening for accommodating a shaft section. The outer sleeve may likewise have an opening for accommodating a shaft section. One of the shaft sections may be inserted in each case into the opening in the core and the opening in the outer sleeve. The at least one opening in the at least one core and/or the at least one opening in the outer sleeve may have at least one section having toothing. A torque-transmitting connection between the shaft sections and the core or the outer sleeve may be established via the toothing of the openings. For this purpose, the shaft sections may have corresponding external toothing. Alternatively, a shaft section may be integrally formed on the at least one core, or the at least one core may have a one-piece design with a shaft section. The same applies for the connecting section. A shaft section may also be integrally formed on the connecting section, or the connecting section may have a one-piece design with a shaft section.

The device may be designed for use with a drive shaft of a vehicle, in particular a front wheel drive or rear wheel drive vehicle and/or a vehicle having an electric drive.

The present invention further relates to a drive shaft for a vehicle, in particular a front wheel drive vehicle and/or a vehicle having an electric drive, having at least one device. Two shaft sections of the drive shaft may be connected to one another via the device, with transmission of torque but with vibrational decoupling from one another. A drive shaft may transmit torques from the transmission to a driven wheel of a vehicle. A drive shaft may have at least one articulated joint. A drive shaft may have an articulated joint on the wheel side and an articulated joint on the transmission side. The device for vibration decoupling may be situated between the articulated joint on the wheel side and the articulated joint on the transmission side, wherein the device may be connected to the articulated joints via a shaft section in each case. However, the device for vibration decoupling may also be combined with an articulated joint. The device for vibration decoupling may be integrated into the articulated joint, for example. Accordingly, an articulated joint may form a shaft section that is connected to a further shaft section via the device for vibration decoupling.

The present invention further relates to an articulated joint having a device for vibration decoupling, the device being integrated into the articulated joint. Such an articulated joint may be a homokinetic articulated joint, for example.

### BRIEF DESCRIPTION OF THE SEVERAL VIEWS OF THE DRAWINGS

Two embodiments of the invention are described below with reference to the appended figures. In the figures:

FIG. 1 shows a perspective view of a device for vibration decoupling according to a first embodiment;

FIG. 2 shows a top view of the device according to the first embodiment;

FIG. 3 shows a sectional view of the section line in FIG. 2;

FIG. 4 shows a side view of the device according to the first embodiment;

FIG. 5 shows a sectional view along the section line V-V in FIG. 4;

FIG. 6 shows a top view of a core of the device according to FIGS. 1 through 5 and a damping layer mounted thereon;

FIG. 7 shows a sectional view along the section line VII-VII in FIG. 6;

FIG. 8 shows a side view of the device according to the first embodiment;

FIG. 9 shows a sectional view along the section line IX-IX in FIG. 8;

FIG. 10 shows a perspective view of a device for vibration decoupling according to a second embodiment; and

FIG. 11 shows a top view of the device according to FIG. 10.

### DETAILED DESCRIPTION OF THE INVENTION

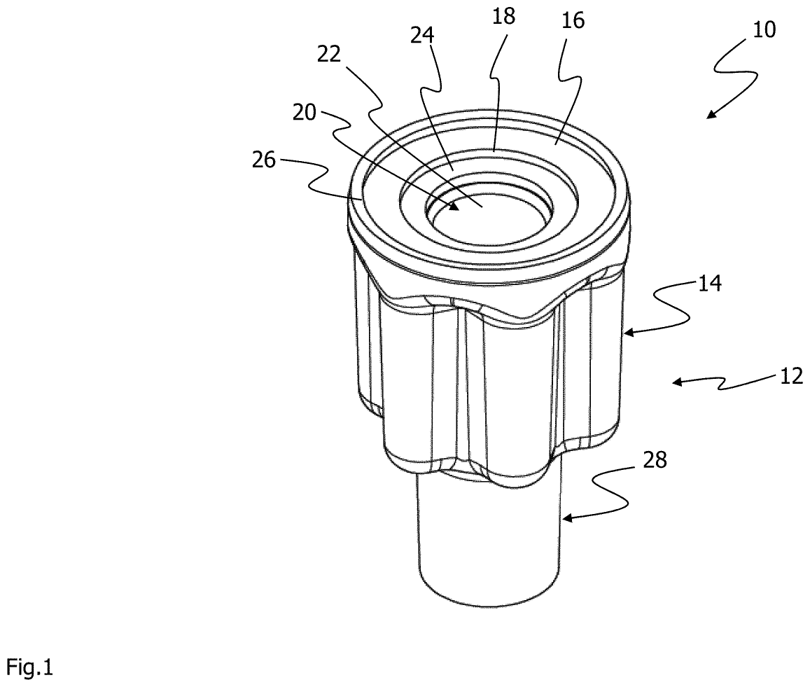

FIG. 1 shows a perspective view of a device 10 for vibration decoupling. The device 10 has an outer sleeve 12. The outer sleeve 12 has a receiving section 14 that may be closed via a closure element 16. The closure element 16 has an opening 18. The core 20, which is accommodated in the receiving section 14, is discernible in the opening 18. The core 20 has an opening 22. A damping layer 24 that extends to the edge of the opening 22 in the core 20 is discernible between the core 20 and the closure element 16. An edge 26 of the receiving section 14 or of the outer sleeve 12 may be deformed in order to fasten the closure element 16 to the outer sleeve 12.

The opening 22 in the core 20 may be used to accommodate a shaft section, not shown in FIG. 1. In addition to the receiving section 14, the outer sleeve 12 has a connecting section 28 that adjoins the receiving section 14 and that may be used to connect the outer sleeve 12 to a shaft section, not shown. The connecting section 28 has an essentially tubular design.

With the exception of the edge 26, the receiving section 14 of the outer sleeve 12 has an undulating contour. The core 20 that is accommodated in the receiving section 14 has a corresponding outer contour, so that torques may be transmitted via the corresponding contours of the core 20 and of the outer sleeve 12.

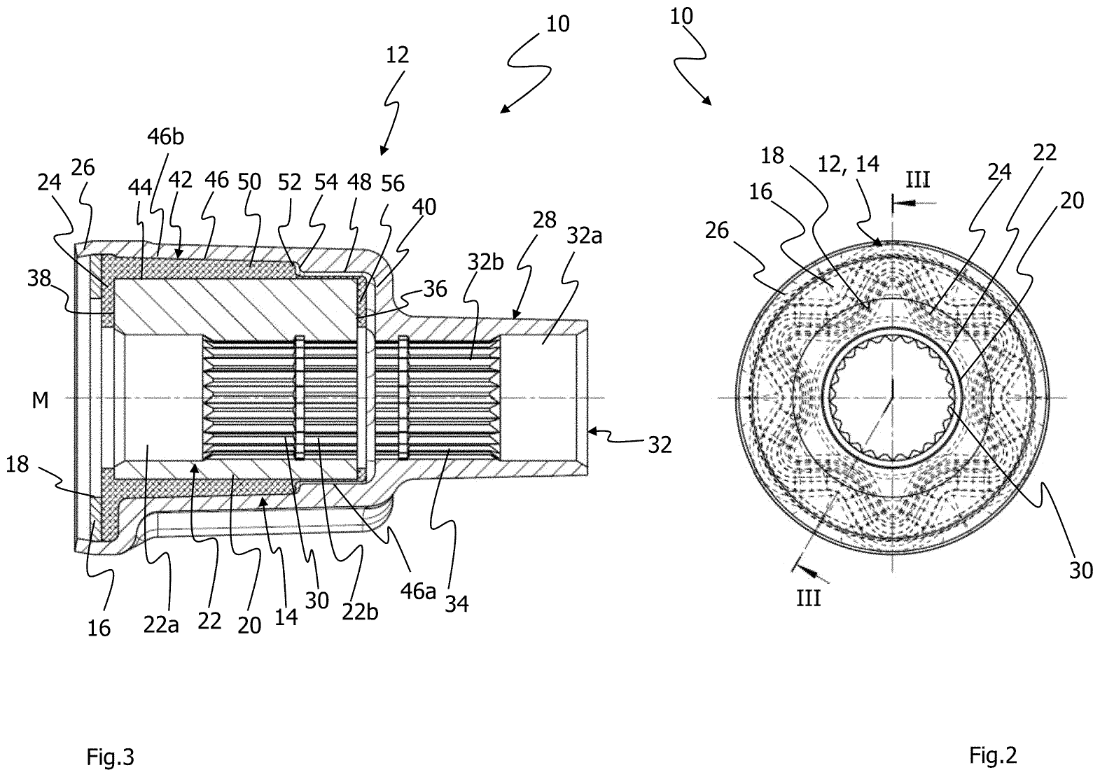

FIG. 2 shows a top view of the device 10. The core 20 is accommodated in the receiving section 14 of the outer sleeve 12. The opening 22 in the core 20 has toothing 30 that protrudes inwardly in the radial direction. The damping layer 24 is discernible between the closure element 16 and the core 20. The closure element 16 is held on the outer sleeve 12 via the deformed edge 26. The contours of the receiving section 14 of the outer sleeve 12 and of the core 16 are illustrated by dashed lines in FIG. 2. These contours of the receiving section 14 and of the core 16 are discussed in greater detail below. According to this embodiment, the edge 26 of the outer sleeve 12 has a circular cross section. Thus, the edge 26 does not have the contours, illustrated by the dashed lines, of the remaining sections of the receiving section 14 and of the core 20. The closure element 16 has a disk-shaped design.

FIG. 3 shows a sectional view along the section line III-III in FIG. 2. FIG. 3 shows the outer sleeve 12 and the core 20. The core 20 is accommodated in the receiving section 14 of the outer sleeve 12. In addition to the receiving section 14, the outer sleeve 12 has the connecting section 28. The connecting section 28 has an essentially tubular design. The connecting section 28 has an opening 32 which in the load-free state of the device 10 illustrated in FIG. 3 is coaxial with the opening 22 in the core 20. The opening 32 has two sections: 32a, and 32b, which is provided with toothing 34. The section 32a extends between an end-face surface of the connecting section 28 and the toothing 34. The section 32a thus forms an axial end section of the opening 32. The diameter of the opening 32 in the section 32a is slightly larger than the diameter of the section 32b having the toothing 34. Inserting a shaft section into the opening 32 and engaging it with the toothing 34 of the shaft section may be simplified in this way.

The core 20 is completely accommodated in the receiving section 14, so that the core is situated inside the receiving section 14 over the entire axial extension of the core 20. The core 20 has two end-face surfaces 36 and 38. At the transition between the connecting section 28 and the receiving section 14 the cross section of the outer sleeve 12 expands in the radial direction, thus forming a base 40 of the receiving section 14. The first end-face surface 36 faces the base 40 of the receiving section 14. The second end-face surface 38 faces the closure element 16, and is thus situated in the area of an axial end of the outer sleeve 12 or of the receiving section 14.

The opening 22 in the core 20 likewise has two sections 22a and 22b. The toothing 30 is formed in the section 22b. The section 22a extends between the end-face surface 38 and the section 22b having the toothing 30. The section 22a has a slightly larger diameter than the section 22b having the toothing 30. The insertion of a shaft section (not shown) may be simplified in this way.

A first damping layer 42 is provided in the radial direction between the core 20 and the outer sleeve 12. The first damping layer 42 extends between an outer contour 46 of the core 20 and the inner contour 44 of the outer sleeve 12. The thickness of the first damping layer 42 in the radial direction changes along its axial extension. The first damping layer 42 has a first section 48 and a second section 50 that adjoin one another in the axial direction. The first damping layer 42 is provided with a step 52, which forms the transition between the first section 48 and the second section 50. A step or a shoulder 54 is likewise formed on the inner contour 42 of the outer sleeve 12, in the area of the step 52 of the first damping layer. The first section 48 of the first damping layer 42 extends between the first end-face surface 36 of the core 20 and the step 52 of the damping layer 42 or the step 54 at the outer sleeve 12. The second section 50 of the first damping layer 42, starting from the steps 52 and 54, extends essentially to the second end-face surface 38 of the core 20. The first damping layer 42 has an essentially constant radial thickness d in the first section 48. The radial thickness d of the first damping layer 42 abruptly increases at the step 52. Starting from the step 52, the radial thickness d of the first damping layer 42 increases essentially continuously in the direction of the second end-face surface 38 of the core 20.

The inner contour 44 of the outer sleeve 12 has a design that corresponds to the first damping layer 42. Starting from the base 40, the inner contour 42 of the receiving section 14 extends in the section 46a initially essentially parallel to the longitudinal axis M of the device 10. The inner contour 42 here has an essentially constant distance from the outer contour 44 of the core 20. The distance from the core 20 increases abruptly at the step 54. Starting from the step 54, the distance from the core 20 in section 46b continues to essentially continuously increase in the direction of the closure element 16. Beginning at the step 54, the receiving section 14 thus expands conically.

A second damping layer 56 extends between the first end-face surface 36 of the core 20 and the base 40 of the receiving section 14. The base 40 and the first end-face surface 36 extend essentially parallel to one another, at least in sections. The second damping layer 56 has an essentially constant thickness in the axial direction. The thickness of the second damping layer 56 in the axial direction is greater than the radial thickness of the first damping layer 42 in the section 48, but smaller than the radial thickness of the first damping layer 42 in the section 50.

The damping layer 24 discernible in FIGS. 1 and 2 forms a third damping layer that extends along the second end-face surface 38 of the core 20. The third damping layer 24 extends in sections between the second end-face surface 38 of the core 20 and the closure element 16. The axial thickness of the third damping layer 24 is greater than the axial thickness of the second damping layer 56.

The end-face surfaces 36 and 38 and the outer contour 44 of the core 20 are essentially completely covered with the elastic material of the elastic damping layer the 24, 42, and 56. The first damping layer 42, the second damping layer 56, and the third damping layer 24 may have a one-piece design, and may be fixedly attached to the core 20.

According to this embodiment, the edge 26 of the receiving section 14 has a circular cross section. The closure element 16 has a disk-shaped design, and may be fastened to the outer sleeve 12 by deforming the edge 26. The closure element 16 is used to pretension the damping layer 24, 42, and 56 in the axial direction.

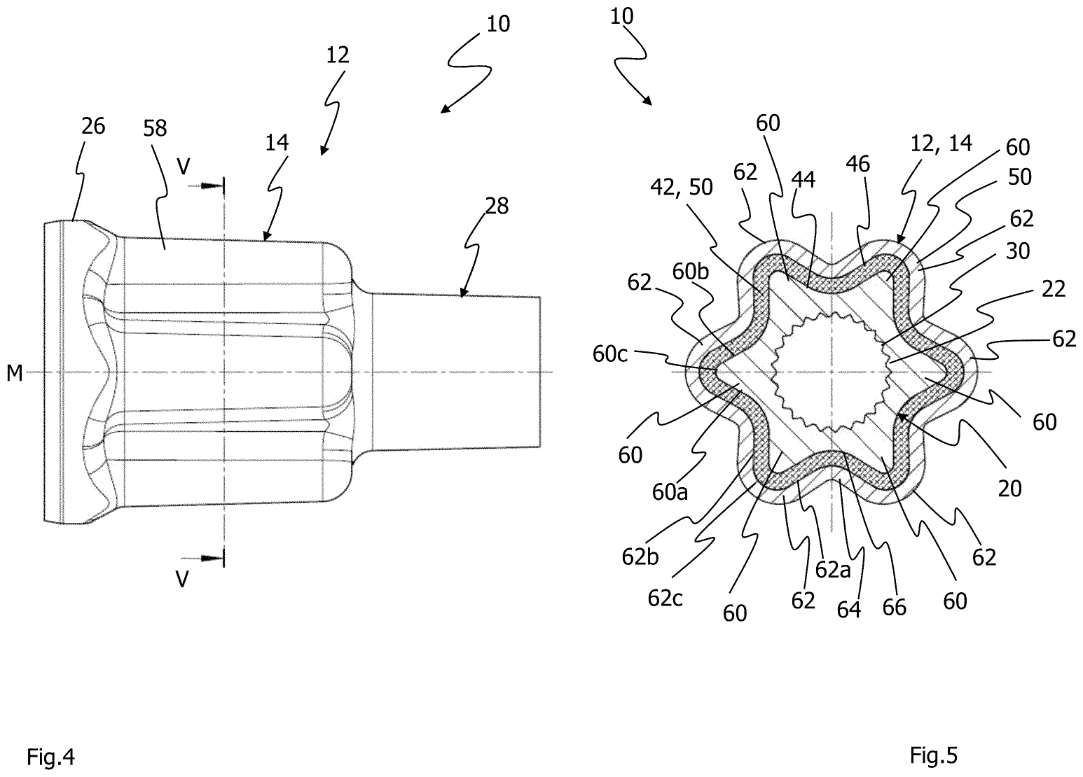

FIG. 4 shows a side view of the device 10. The outer sleeve 12 has the receiving section 14 for accommodating the core 20 and the connecting section 28. The edge 26 is adjoined by a section 58 of the receiving section 14 having the undulating outer contour. The section 58 having the undulating outer contour is adjoined by the connecting section 28. The section 58 of the receiving section 14 having the undulating outer contour thus extends between the connecting section 28 and the edge 26 of the receiving section 14.

FIG. 5 shows a sectional view along the section line V-V in FIG. 4. The contours of the receiving section 14 of the outer sleeve 12 and of the core 20 are discernible in the sectional view according to FIG. 5. The outer contour of the receiving section 14 in section 58 (see FIG. 4) has a design that corresponds to the inner contour 46 of the receiving section 14. The inner contour 46 of the receiving section 14 and the outer contour 44 of the core 20 have a mutually complementary design. The core 20 has radial protrusions 60 that extend radially outwardly. Each protrusion 60 is formed by two wall surface sections 60a and 60b that are connected to one another via a curved section 60c. The protrusions 60 are at least partially accommodated in radially outwardly extending receiving areas 62 of the inner contour 46 of the receiving section 14. The receiving areas 62 are formed by two walls 62a and 62b that are connected to one another via a curved section 62c. The receiving areas 62 of the receiving section 14, i.e., the walls 62a and 62b of two adjacent receiving areas 62, are connected to one another via curved sections 64. Between the protrusions 62, the core 20 has curved surface sections 66 that connect the protrusions 62 to one another. The outer contour 44 of the core 20 and the inner contour 46 of the receiving section 14 have essentially the same or a similar curvature in the sections 64 and the surface sections 66. For reasons of clarity, only one section 64 and one section 66 are provided with reference numerals in FIG. 5.

Due to the above-described contours of the core 20 and of the receiving section 14, a space is formed between the outer contour 44 of the core 20 and the inner contour 46 of the receiving section 14, in which the first damping layer 42 extends (see FIG. 3). During the torque transmission, the core 20 and the outer sleeve 12 may be twisted relative to one another with compression of the damping layer 42. The protrusions 60 of the core 20 may approach the receiving areas 62 of the outer contour 64 of the receiving section 14 with compression of the damping layer 42. In other words, one of the wall surface sections 60a and 60b of a protrusion 60 may approach a wall 62a or 62b of one of the receiving areas 62 of the receiving section 14, thus compressing the damping layer 42 between these two portions. The greater the torque to be transmitted, the more closely the protrusions 60 approach a wall 62a or 62b of a receiving area 62. An approach of the protrusions 60 toward one of the walls 62a or 62b takes place, with corresponding torques to be transmitted, until further compression of the damping layer 42 is no longer possible. In this state, torque transmission takes place more or less directly from the protrusions 60 to the receiving section 14, or vice versa.

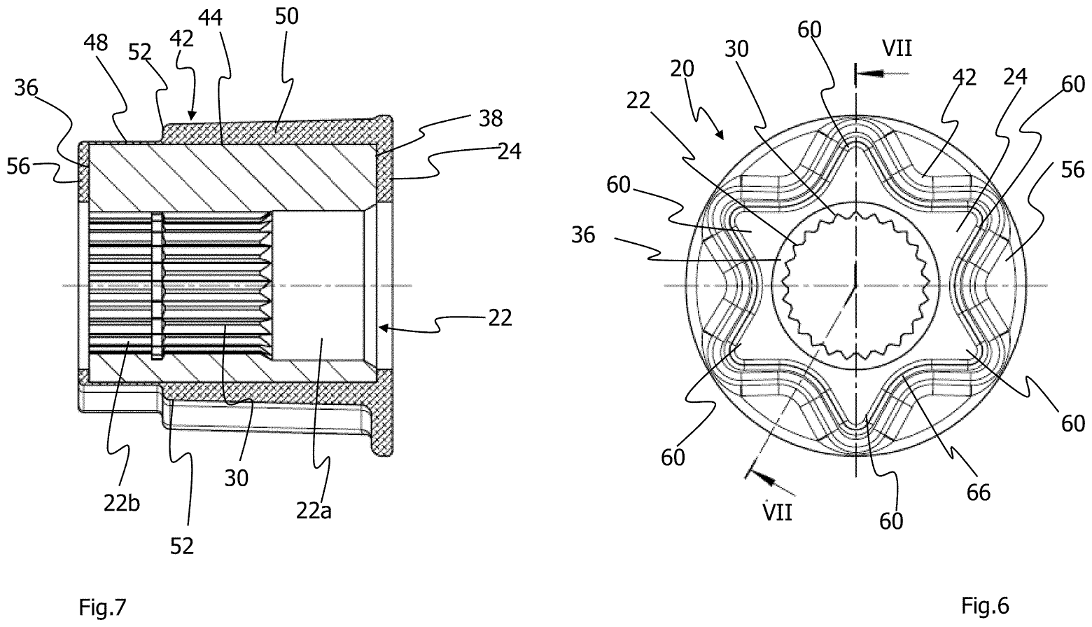

FIG. 6 shows a top view of the core 20 and the damping layers 24, 42, and 56 attached thereto. The damping layers 24, 42, and 56 may be vulcanized to the core 20. The first damping layer 42 extends along the outer contour of the core 12, so that the protrusions 60 and the sections 66 between the protrusions 60 are covered by the first damping layer 42. The first end-face surface 36 is provided in sections with the second damping layer 24, which extends to the edge of the opening 22 in the core 20. The third damping layer 24 has a disk-shaped design, since it extends into the circular edge 26 of the outer sleeve 12 (see FIGS. 2 and 3).

FIG. 7 shows a sectional view along the section line VII-VII in FIG. 6. The damping layers 24, 42, and 56 are vulcanized to the core 20. According to this embodiment, the damping layers 24, 42, and 56 have a one-piece design. The first damping layer 42 extends along the outer contour or the outer surface 44 of the core 20. The first damping layer 42 has two sections 48 and 50 that are connected to one another via the step 52 that is formed on the damping layer 42. In the section 48 the first damping layer 42 has an essentially constant thickness d, which abruptly increases at the step 52. From the step 52, the radial thickness d of the first damping layer 42 increases essentially continuously to the third damping layer 24 or to the second end-face surface 38 of the core 20. The first damping layer 42 is connected via its section 50 to the third damping layer 24. The section 48 of the first damping layer 42 merges into the second damping layer 56, which extends along the first end-face surface 36 of the core 12. The second damping layer 56 essentially completely covers the first end-face surface 36. The third damping layer 56 extends along the second end-face surface 38, and protrudes beyond same in sections in the radial direction in order to be accommodated in the edge area 26 having a circular section (see FIGS. 2 and 3).

The unit that is formed by the damping layers 24, 42, and 56 and the core 20 may be inserted into the receiving section 14 of the outer sleeve 12. The damping layers 42 and 56 then directly contact the receiving section 14. However, the damping layers 42 and 56 are not attached to the receiving section. The damping layers 24, 42, and 56 may be pretensioned in the axial direction by the closure element 16. The axial pretensioning may be adjusted via the positioning or the fastening position of the closure element 16 on the receiving section 14.

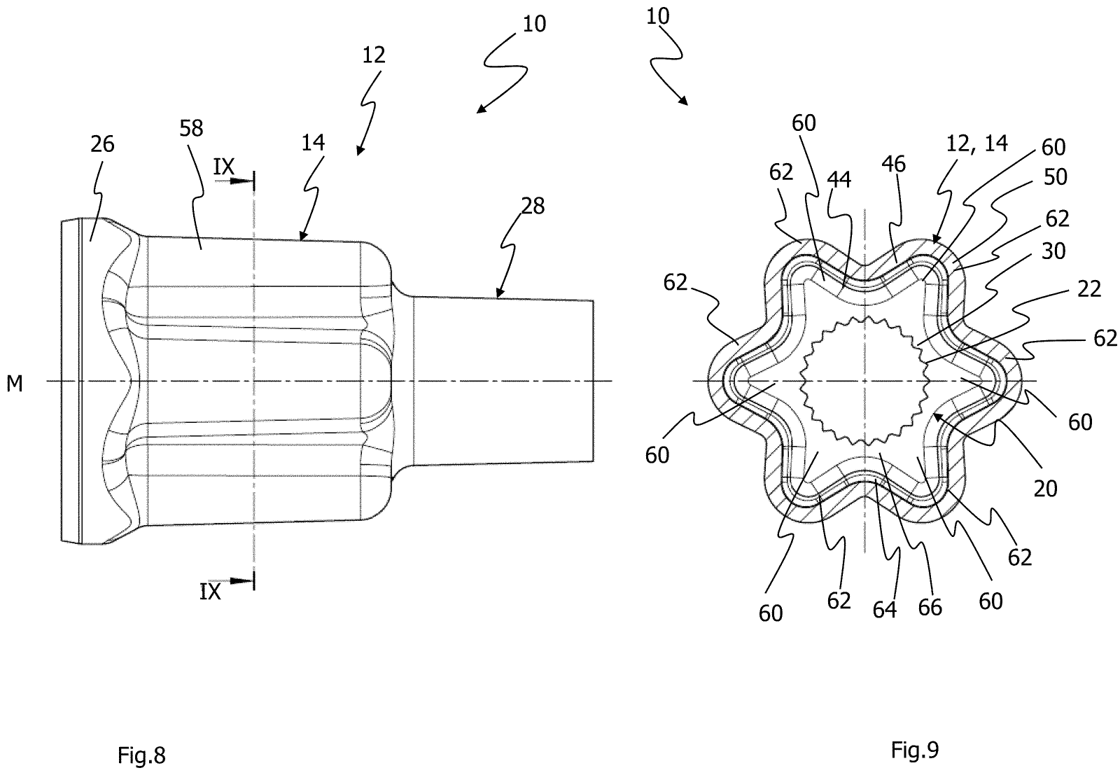

FIG. 8 shows a side view of the device 10, corresponding to the side view according to FIG. 4. FIG. 9 shows a sectional view along the section line IX-IX in FIG. 8. In FIGS. 8 and 9 the outer sleeve 12 and the core 20 are shown without damping layers so that the contours 44 and 46 of the receiving section 14 and of the core 20 are discernible. The core 20 has the radial protrusions 60, which extend into the radially outwardly extending receiving areas 62 of the outer sleeve 12. The inner contour 46 of the receiving section 14 and the outer contour 44 of the core 20 thus have a mutually complementary design.

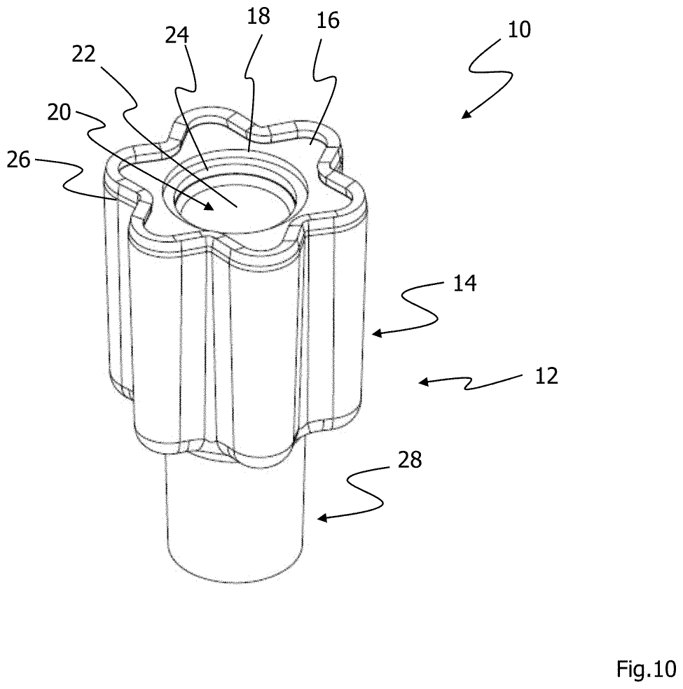

FIG. 10 shows a perspective view of a device 10 according to a second embodiment. The device 10 has an outer sleeve 12 and a core 20. The outer sleeve 12 has a receiving section 14 and a connecting section 28. The core 20 is accommodated in the receiving section 14. The receiving section 14 is closed via a closure element 16. The closure element 16 and the core 20 have openings 18 and 22, respectively. A damping layer 24 between the closure element 16 and the core 20 is discernible.

The sole difference between the device 10 according to the first embodiment and the device 10 according to the second embodiment, illustrated in FIG. 10, lies in the edge 26 of the receiving section 14 no longer having a circular cross section according to the second embodiment (see FIGS. 1 through 3), but instead being provided with an undulating contour, the same as the remaining receiving section 14. For this reason, the closure element 16 is likewise provided with a contour that corresponds to the contour of the receiving section 14.

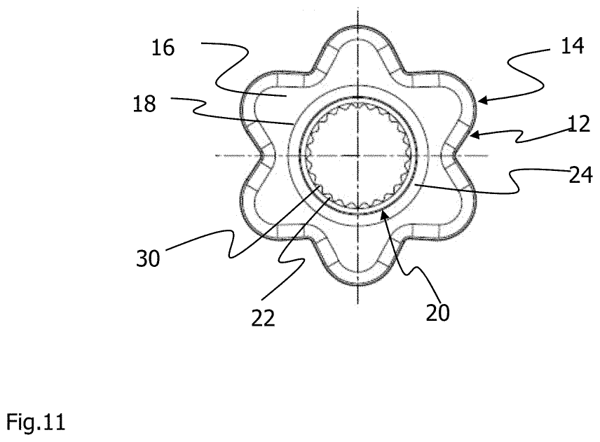

FIG. 11 shows a top view of the device 10. The core 20 is accommodated in the receiving section 14 of the outer sleeve 12. The core 20 has the opening 22, with toothing 30 that protrudes in the radial direction. A damping layer 24 is discernible between the closure element 16 and the core 20. The closure element 16 is held on the outer sleeve 12 via the deformable edge 26. As is apparent in FIG. 11, the receiving section 14 has a continuous contour. Accordingly, the closure element 16 has a contour that matches the contour of the receiving section 14 to allow it to be fastened to the receiving section 14.

A device 10 for vibration decoupling for a drive shaft or side shaft of a vehicle is provided by the present invention. Bending vibrations and rotational vibrations of a drive shaft of a vehicle may be reduced by means of the device. The core 20 together with one or more damping layers 24, 42, and 56 may be inserted into the outer sleeve. The closure element 16 may pretension the damping layers 24, 42, and 56 in the axial direction, as the result of which the service life of the device 10 may be extended and the rigidity of the device 10 may be increased. A multistep rigidity characteristic curve may be achieved via the different thicknesses of the damping layers 24, 42, and 56, and in particular via the different radial thicknesses of the first damping layer 42. The device 10 may thus have progressive rigidity.

1. A device for vibration decoupling of two shaft sections of a drive shaft of a vehicle, the device comprising:
at least one core that has a radial outer contour with radial protruding sections and that is connectable to one of the shaft sections;
an outer sleeve that has at least one receiving section, the at least one receiving section having a radial inner contour with radial receiving areas, the outer sleeve having a connecting section for connection to one of the shaft sections;
wherein the radial outer contour of the at least one core and the radial inner contour of the at least one receiving section have a mutually complementary design;
wherein the at least one core is accommodated in the at least one receiving section of the outer sleeve;
wherein at least one first damping layer is situated in the radial direction between the radial inner contour of the at least one receiving section and the radial outer contour of the core; and
wherein at least one second damping layer extends in the axial direction between a first end-face surface of the at least one core and the at least one receiving section.

2. The device according to claim 1, wherein at least the radial inner contour of the at least one receiving section has a conical design, at least in one section.

3. The device according to claim 1, wherein the radial inner contour of the at least one receiving section has a section in which the radial inner contour extends at least essentially parallel to the longitudinal axis.

4. The device according to claim 1, wherein the radial inner contour of the at least one receiving section has at least one step.

5. The device according to claim 1, wherein the at least one first damping layer has at least one section in which the radial thickness of the at least one first damping layer changes.

6. The device on according to claim 1, wherein the at least one first damping layer has at least one section in which its radial thickness remains constant.

7. The device according to claim 1, wherein the at least one first damping layer has at least one step at which the radial thickness of the at least one first damping layer abruptly changes.

8. The device according to claim 1, wherein the device has a third damping layer that extends along a second end-face surface of the at least one core.

9. The device according to claim 1, wherein the device has at least one closure element that holds the at least one core in the receiving section of the outer sleeve.

10. The device according to claim 1, wherein at least the at least one first damping layer and the at least one second damping layer are fixedly mounted on the at least one core.

11. The device according to claim 1, further comprising at least one selected from the group consisting of the at least one core having at least one opening for accommodating a shaft section and the connecting section of the outer sleeve having at least one opening for accommodating a shaft section.

12. The device according to claim 11, further comprising at least one selected from the group consisting of the at least one opening in the at least one core having at least one section having toothing and the at least one opening in the outer sleeve having at least one section having toothing.

13. The device according to claim 1, further comprising at least one selected from the group consisting of the at least one core comprises a shaft section and the connecting section of the outer sleeve comprises a shaft section.

14. The device according to claim 1 operably connected to a drive shaft of a vehicle, wherein the vehicle comprises at least one selected from the group consisting of a front wheel drive vehicle a rear wheel drive vehicle, and a vehicle having an electric drive.

15. A vehicle comprising at least one drive shaft and at least one device according to claim 1 operably connected to the at least one drive shaft, wherein the vehicle comprises at least one selected from the group consisting of a front wheel drive vehicle and a vehicle having an electric drive.

16. The vehicle according to claim 15, wherein the at least one drive shaft has at least one articulated joint; the at least one device being positioned a distance from the at least one articulated joint or being integrated into the at least one articulated joint.

17. An articulated joint having a device according to claim 1, wherein the device is integrated into the articulated joint.

18. The device according to claim 2, wherein the radial inner contour of the at least one receiving section has a section in which the radial inner contour extends at least essentially parallel to the longitudinal axis.

19. The device according to claim 2, wherein the radial inner contour of the at least one receiving section has at least one step.

20. The device according to claim 2, wherein the at least one first damping layer has at least one section in which the radial thickness of the at least one first damping layer changes.
